(19) United States
(12) Patent Application Publication
(10) Pub. No.: US 2003/0228862 A1
(43) Pub. Date: Dec. 11, 2003

(54) Portable terminal apparatus

(75) Inventor: Yoshihisa Nagashima, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/452,580

(22) Filed: Jun. 3, 2003

(30) Foreign Application Priority Data
Jun. 5, 2002 (JP) 164188/2002

(51) Int. Cl. H04M 3/16

(52) U.S. Cl. 455/412.1; 455/412.2

(57) ABSTRACT

A portable terminal apparatus includes a radio section, an input section, a display section, a memory section, mail transmission sections, mail text editing sections, and a mail destination editing section. The radio section transmits/receives a radio signal. The input section inputs data. The display section displays the input data. The memory section stores the data. The mail transmission sections are arranged in correspondence with a plurality of mail transmission services to transmit mail. The mail text editing sections are arranged in correspondence with the mail transmission services to edit e-mail within a mail transmission condition defined for each mail transmission service. The mail destination editing section designates a mail transmission service in accordance with a destination, activates a corresponding mail text editing section, and edits the destination of the other party to which the e-mail is to be transmitted. A mail editing method and recording medium are also disclosed.

### BACKGROUND OF THE INVENTION

The present invention relates to a portable terminal apparatus such as a cellular phone set and a method of editing e-mail in the portable terminal apparatus.

Various telecommunications carriers are nowadays providing their original communication services. They include a communication service called a mail transmission service. Examples of mail transmission services are Internet mail, message service, and pager.

Portable terminal apparatuses that are widely used in recent years are designed to cope with the plurality of mail transmission services. E-mail is transmitted using one of the plurality of mail transmission services.

A conventional portable terminal apparatus 600 shown in FIG. 12 comprises a single mail destination editing section 601, a single mail text editing section 602, and three mail transmission sections 603a, 603b, and 603c.

The mail transmission sections 603a, 603b, and 603c cope with different mail transmission services.

In the portable terminal apparatus 600, the mail text editing section 602 creates the text of e-mail. Then, one of the mail transmission sections 603a, 603b, and 603c is selected. The e-mail is transmitted by the selected mail transmission section.

The mail destination editing section 601 has, e.g., a memory. This memory stores a plurality of mail addresses. The user of the portable terminal apparatus 600 can determine the destination of e-mail by selecting one of the plurality of mail addresses stored in the memory.

Alternatively, the mail destination editing section 601 has, e.g., a plurality of keys representing numbers and characters. The user of the portable terminal apparatus 600 can input the destination of e-mail to the portable terminal apparatus 600 through these keys.

The allowable character type and the maximum number of transmittable characters change between the mail transmission sections 603a, 603b, and 603c. For this reason, the mail text editing section 602 is designed to cover all the allowable character types and maximum numbers of transmittable characters of the plurality of mail transmission sections 603a, 603b, and 603c.

More specifically, in the mail text editing section 602, the allowable character types are defined by combining the character types specified for the mail transmission sections 603a, 603b, and 603c by “OR”. Additionally, in the mail text editing section 602, the maximum value of the maximum numbers of transmittable characters specified for the mail transmission sections 603a, 603b, and 603c is selected as the maximum number of characters that can be input to the portable terminal apparatus 600.

However, the conventional portable terminal apparatus 600 described above has the following problems.

As the first problem, the user of the portable terminal apparatus 600 for creating e-mail must always execute the step of selecting one of the mail transmission sections 603a, 603b, and 603c after he/she creates e-mail.

This is because a specific one of the mail transmission sections 603a, 603b, and 603c cannot be designated at the time of character input to the mail destination editing section 601 and mail text editing section 602.

As the second problem, at the time of character input to the mail text editing section 602, the user of the portable terminal apparatus 600 needs to do operation while being aware of one of the mail transmission sections 603a, 603b, and 603c, which should be selected later.

The reason for this is as follows. The allowable character types and maximum inputtable number of characters in the mail text editing section 602 are designed to cover the plurality of mail transmission sections 603a, 603b, and 603c. Hence, a character type or a number of characters that are unallowable for a specific one of the mail transmission sections 603a, 603b, and 603c can be input. For example, a character type that is unallowable in the mail transmission section 603a but allowable in the mail transmission section 603b can be input to the mail text editing section 602.

As a result, if the user inputs an unallowable character, no correct message can be transmitted to the other party.

As the third problem, even when one mail transmission service handles a plurality of character codes in correspondence with languages used for transmission, the user must perform operation while being aware of the character type or the maximum number of transmittable characters, like the second problem.

This is because even when in a mail transmission service that handles a plurality of character codes, the allowable character type or the maximum number of transmittable characters changes depending on the character code.

For example, Japanese Patent Laid-Open No. 11-250066 has proposed an e-mail apparatus which temporarily transmits the text of e-mail created in Japanese to a translation server, causes the translation server to translate the text into English, and transmits the e-mail translated into English to a designated destination.

In addition, Japanese Patent Laid-Open No. 2001-101105 has proposed an e-mail creating apparatus which comprises a means for inputting a text to be transmitted, an input form storage means for storing a plurality of input forms having different display sizes, a means for, at the time of creating e-mail, creating an e-mail text as e-mail in accordance with the input form stored in the input form storage means, and a display means for displaying the created e-mail.

Furthermore, Japanese Patent Laid-Open No. 2001-344173 has proposed an e-mail transmission apparatus which has a function of transmitting e-mail to an e-mail server apparatus on a network, and an editing function of creating e-mail. When e-mail is to be transmitted, it is determined whether the e-mail address of a transmission destination indicates a portable terminal apparatus having a limitation on the number of characters that can be received. When the transmission destination is a portable terminal apparatus, only the summary of the e-mail text is transmitted to the portable terminal apparatus. When the transmission destination is an apparatus other than a portable terminal apparatus, both the text and summary of the e-mail are transmitted to the apparatus.

Even in the portable terminal apparatuses proposed in these prior arts, however, the second problem described above remains unsolved. At the time of inputting an e-mail text, an unallowable character type or characters more than the transmittable number may be input because of the lack of limitations on the character type and the number of transmittable characters.

### SUMMARY OF THE INVENTION

It is an object of the present invention to provide a portable terminal apparatus which can use a plurality of mail transmission services and allows a user to edit e-mail without being aware of the limitation on the character type allowable in each mail transmission service or the limitation on the maximum number of transmittable characters in each mail transmission service and a mail editing method in the portable terminal apparatus.

In order to achieve the above object, according to the present invention, there is provided a portable terminal apparatus comprising radio means for transmitting/receiving a radio signal, data input means for inputting data, display means for displaying the data input by the input means, a memory which stores the data, a plurality of mail transmission means, arranged in correspondence with a plurality of mail transmission services, for transmitting mail, a plurality of mail text editing means, arranged in correspondence with the plurality of mail transmission services, for editing e-mail within a mail transmission condition defined for each mail transmission service, and mail destination editing means for designating a mail transmission service in accordance with a destination, activating a corresponding one of the mail text editing means, and editing the destination of the other party to which the e-mail is to be transmitted.

### BRIEF DESCRIPTION OF THE DRAWINGS

FIG. 1 is a block diagram showing the structure of a portable terminal apparatus according to the first embodiment of the present invention;

FIG. 2 is a block diagram showing the structure of the control section of the portable terminal apparatus according to the first embodiment;

FIG. 3 is a schematic view showing the data structure of telephone directory data stored in the memory section of the portable terminal apparatus according to the first embodiment;

FIG. 4 is a flow chart showing the operation of the portable terminal apparatus according to the first embodiment of the present invention;

FIG. 5 is a block diagram showing the structure of the control section of a portable terminal apparatus according to the second embodiment;

FIG. 6 is a schematic view showing the data structure of telephone directory data stored in the memory section of the portable terminal apparatus according to the second embodiment;

FIG. 7 is a flow chart showing the operation of the portable terminal apparatus according to the second embodiment of the present invention;

FIG. 8 is a flow chart showing the operation of a portable terminal apparatus according to the third embodiment of the present invention;

FIG. 9 is a block diagram showing the structure of the control section of a portable terminal apparatus according to the fourth embodiment;

FIG. 10 is a flow chart showing the operation of the portable terminal apparatus according to the fourth embodiment of the present invention;

FIG. 11 is a flow chart showing a process from e-mail text creation to e-mail transmission; and

FIG. 12 is a block diagram showing the structure of a conventional portable terminal apparatus.

### DESCRIPTION OF THE PREFERRED EMBODIMENTS

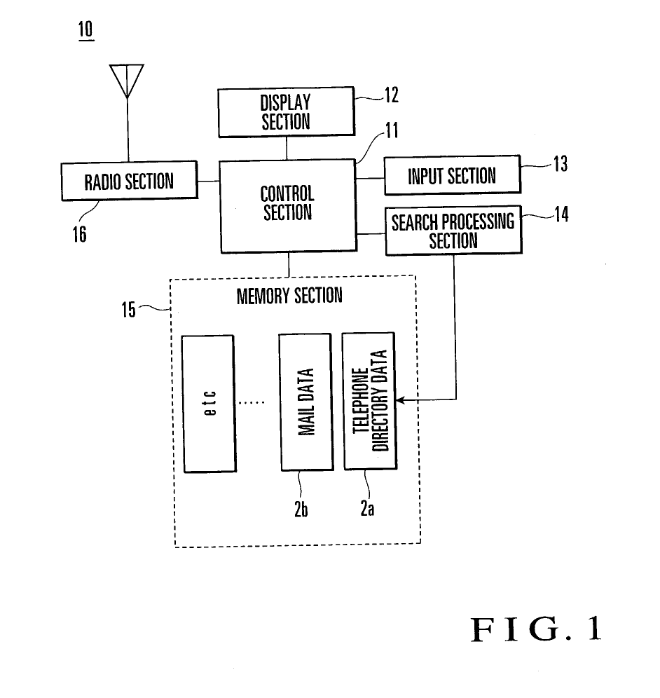

A portable terminal apparatus 10 according to the first embodiment comprises a control section 11, display section 12, input section 13, search processing section 14, memory section 15, and radio section 16, as shown in FIG. 1.

The control section 11 is connected to the display section 12, input section 13, search processing section 14, memory section 15, and radio section 16 and generally controls their hardware and software operations.

The display section 12 displays a character string input using keys through the input section 13, various kinds of information, or other data.

The input section 13 is constituted by a plurality of buttons including a ten-key pad. The input section 13 has a function of dialing for a phone call and inputting characters.

The memory section 15 stores and manages user data represented by telephone directory data 2a and mail data 2b. The telephone directory data 2a can be searched through the search processing section 14. By the searching, specific data can be read out from the telephone directory data 2a.

The radio section 16 is connected to an antenna. The radio section 16 has a function of browsing external information as well as a function of not only executing voice communication but also transmitting a message of mail or the like.

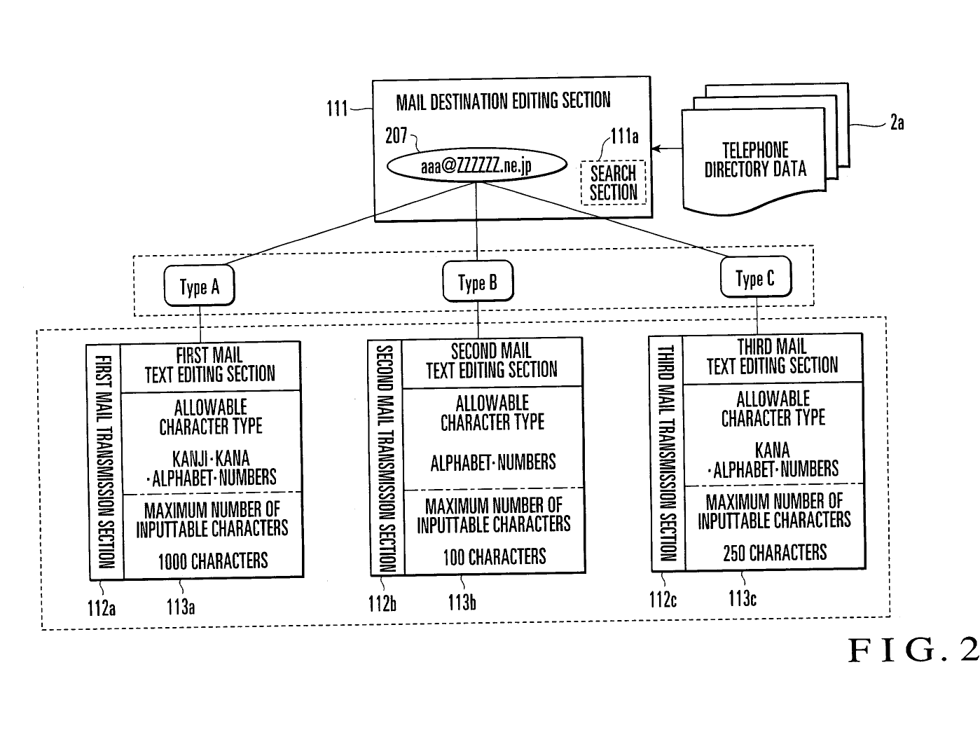

As shown in FIG. 2, the control section 11 comprises one mail destination editing section 111, first to third mail transmission sections 112a, 112b, and 112c, and first to third mail text editing sections 113a, 113b, and 113c.

The mail destination editing section 111 has a function of editing the destination to the other party to which mail is to be transmitted. The mail destination editing section 111 has a search section 111a such as an interface which searches for personal information stored in the telephone directory data 2a. The mail destination editing section 111 can be designed as an editing window to be used to, e.g., input a mail destination.

The first to third mail transmission sections 112a, 112b, and 112c respectively have the first to third mail text editing sections 113a, 113b, and 113c which correspond to various mail transmission services (e.g., original communication services such as Internet mail, message service, and pager provided by telecommunications carriers) in a one-to-one correspondence. Each of the first to third mail transmission sections 112a, 112b, and 112c has software that realizes mail transmission by a corresponding mail transmission service.

The mail text editing sections 113a, 113b, and 113c are designed as editing windows to be used to, e.g., input an e-mail text.

The respective mail transmission services specify allowable character types and maximum numbers of transmittable characters for the first to third mail text editing sections 113a, 113b, and 113c corresponding to the first to third mail transmission sections 112a, 112b, and 112c.

More specifically, as shown in FIG. 2, the first mail text editing section 113a allows four character types, i.e., kanji, kana (hiragana and katakana characters), alphabet, and numbers. The maximum number of transmittable characters (maximum number of input characters) is 1,000. The second mail text editing section 113b allows two character types, i.e., alphabet and numbers. The maximum number of transmittable characters is 100. The third mail text editing section 113c allows three character types, i.e., kana (hiragana and katakana characters), alphabet, and numbers. The maximum number of transmittable characters is 250.

In each of the mail text editing sections 113a, 113b, and 113c, it is impossible to input character types that are unallowable in the mail transmission service. It is also impossible to input characters more than the maximum number of transmittable characters.

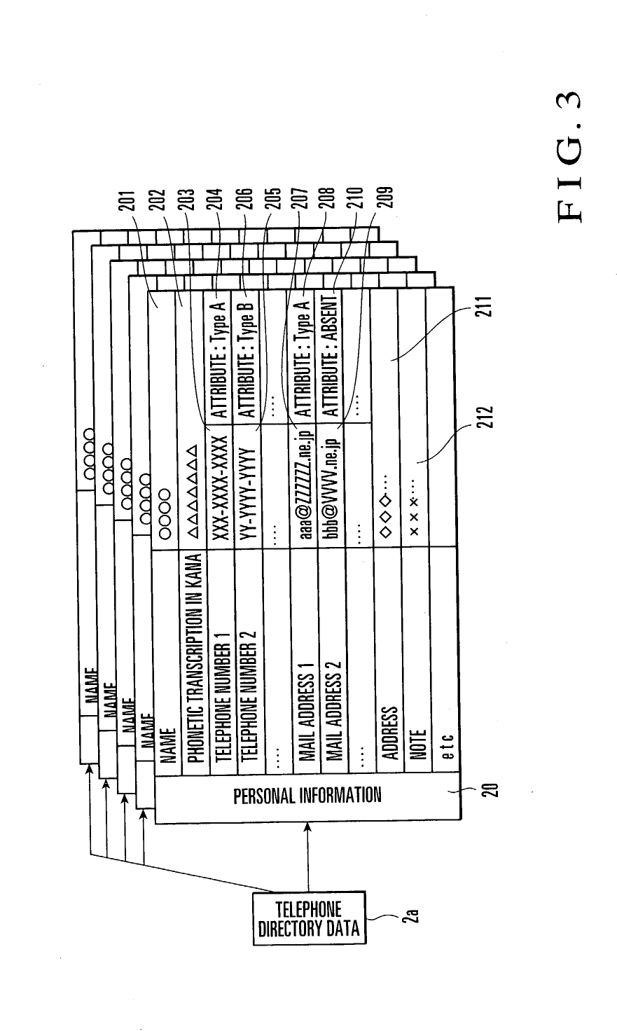

The data structure of the telephone directory data 2a according to this embodiment will be described below with reference to FIG. 3.

A plurality of pieces of personal information 20 are stored in the telephone directory data 2a. Each personal information 20 contains a name 201, phonetic transcription 202 in kana, first telephone number (telephone number 1) 203, second telephone number (telephone number 2) 205, first mail address (mail address 1) 207, second mail address (mail address 2) 209, address 211, note 212, and other information.

Attributes 204 and 206 of telephone numbers are added to the first telephone number 203 and second telephone number 205, respectively. Attributes 208 and 210 of the mail addresses are added to the first mail address 207 and second mail address 209, respectively. More specifically, attribute Type A is added to the first telephone number 203 and first mail address 207. Attribute Type B is added to the second telephone number 205. No attribute is added to the second mail address 209.

These attributes correspond to the mail transmission services in a one-to-one correspondence, as shown in FIG. 2. More specifically, attribute Type A corresponds to the first mail transmission section 112a and first mail text editing section 113a. Attribute Type B corresponds to the second mail transmission section 112b and second mail text editing section 113b. Attribute Type C corresponds to the third mail transmission section 112c and third mail text editing section 113c.

These attributes are used to designate one of the first to third mail transmission sections 112a, 112b, and 112c when the first telephone number 203, second telephone number 205, first mail address 207, or second mail address 209 is designated as the destination of e-mail.

In this embodiment, one attribute is added to one telephone number or mail address. However, a plurality of attributes may be set for one telephone number or mail address.

The attribute need not always be added, like the second mail address 209. In this case, it is assumed that the attribute 210 indicating “no attribute” is added to the second mail address 209.

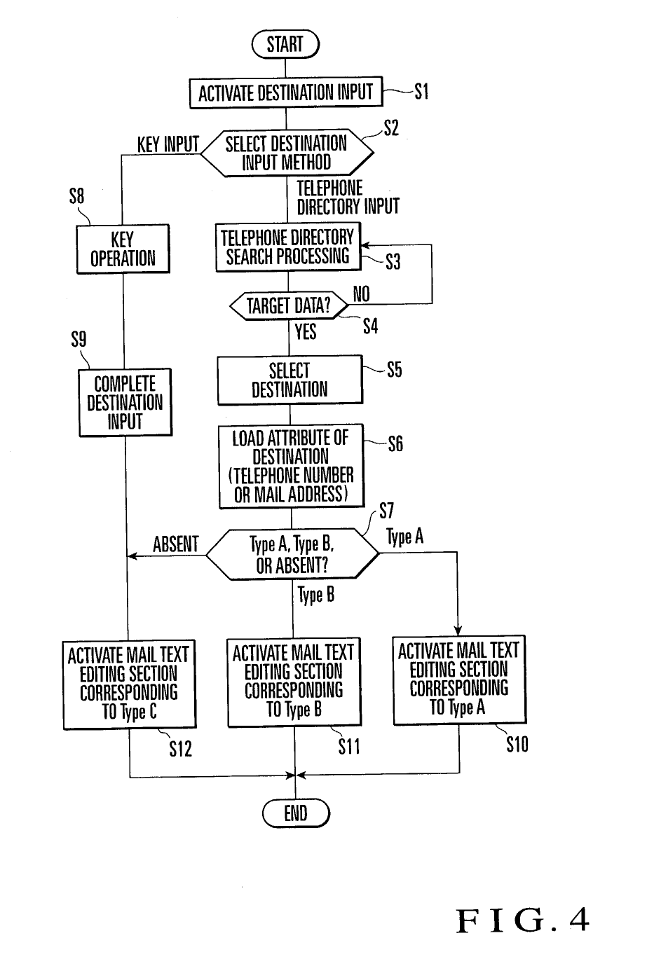

The operation of the portable terminal apparatus 10 according to this embodiment will be described below with reference to FIG. 4.

First, the user of the portable terminal apparatus 10 activates the mail destination editing section 111 to input the address of the other party at the transmission destination (step S1).

A destination can be selected from the telephone directory data 2a and input or directly input through the keys. The user can select and employ one of the methods (step S2).

When input from the telephone directory data 2a is selected as the destination input method (“telephone directory input” is selected in step S2), the search processing section 14 is activated to search the telephone directory data 2a for the target personal information 20 (step S3).

When searching is executed using data such as the name, phonetic transcription in kana, or telephone number, and the target data is found (YES in step S4), the data is designated as the destination (step S5).

If the target data is not found (NO in step S4), the telephone directory data 2a is searched again (step S3).

After the destination is selected (step S5), the attribute added to the destination (telephone number or mail address) is loaded from the personal information 20 (step S6), the type of attribute is determined (step S7), and a mail text editing section corresponding to the attribute is activated (step S10, S11, or S12).

More specifically, when the attribute added to the destination is Type A, the first mail text editing section 113a corresponding to Type A is activated (step S10). When the attribute added to the destination is Type B, the second mail text editing section 113b corresponding to Type B is activated (step S11). When no attribute is added to the destination, the third mail text editing section 113c that is defined in advance to be activated when no attribute is added is activated (step S12).

In this embodiment, when no attribute is added to the destination, the third mail text editing section 113c corresponding to Type C different from Type A and Type B is activated. However, not the third mail text editing section 113c but one of the first mail text editing section 113a and second mail text editing section 113b, which correspond to Type A and Type B, respectively, may be activated.

Generally, when no attribute is designated, a mail text editing section that is expected to be most frequently used in the portable terminal apparatus 10 is activated.

Assume that direct key input (“key input” is selected in step S2) is to be executed instead of input from the telephone directory data 2a (step S8). In this case, even when the destination input is completed (step S9), the destination can be regarded to have no attribute because the personal information 20 in the telephone directory data 2a is not referred to. Hence, in this embodiment, the third mail text editing section 113c corresponding to Type C is activated.

The relationship between the mail destinations/attributes and the mail transmission sections will be described next with reference to FIGS. 2 and 4.

When the destination 207 is input from the telephone directory data 2a to the mail destination editing section 111, the destination 207 has one of three attributes Type A, Type B, and Type C.

When the destination 207 is input not from the telephone directory data 2a but by key input, the destination can be regarded to have no attribute so that the default mail transmission section of the portable terminal apparatus 10 can be automatically selected.

As shown in FIG. 3, when attribute Type A is added to the destination 207, the first mail transmission section 112a that corresponds to attribute Type A in a one-to-one correspondence is selected. The first mail transmission section 112a corresponds to a transmission section for one of the mail transmission services such as the Internet mail, message service, and pager.

The first mail transmission section 112a includes the mail text editing section 113a that corresponds to the first mail transmission section 112a in a one-to-one correspondence.

Generally, in a mail transmission service, the character types and number of characters transmittable as mail are defined in advance. Similarly, the first mail transmission section 112a also has limitations on the allowable character types and the number of inputtable/transmittable characters (maximum number of inputtable characters) in correspondence with the mail transmission service.

For this reason, the user cannot input a character type that is unallowable in the mail transmission service corresponding to the first mail transmission section 112a or characters more than the transmittable number. When the mail text is edited, and then, mail transmission is to be executed, a transmission sequence corresponding to the selected mail transmission service is used.

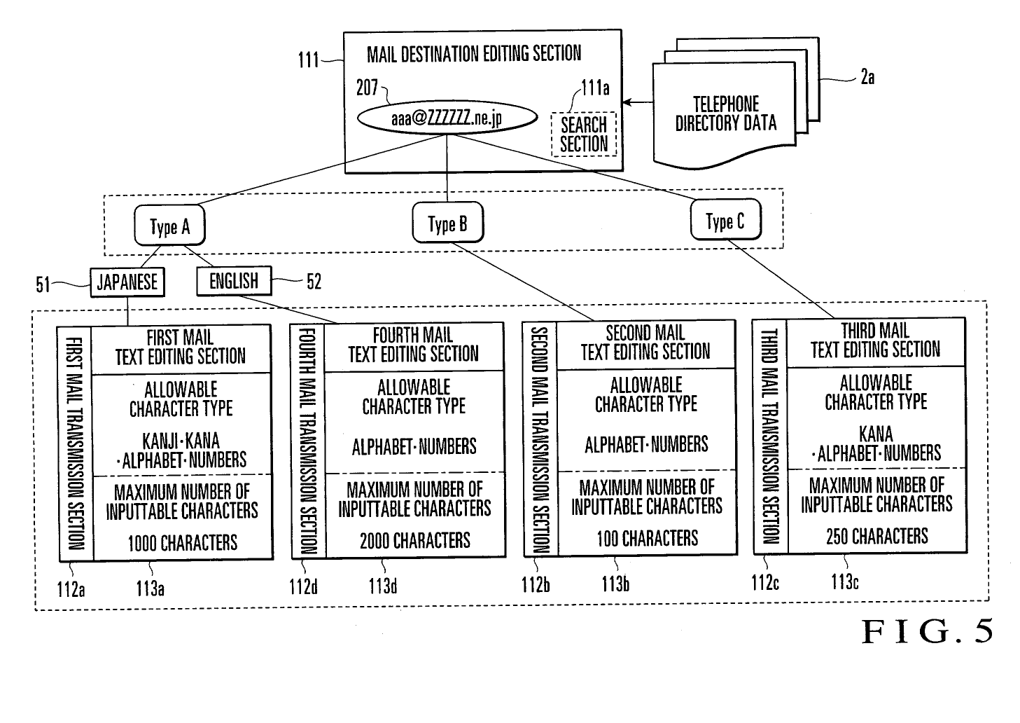

A portable terminal apparatus according to the second embodiment of the present invention has the same structure as that of the portable terminal apparatus 10 according to the first embodiment, as shown in FIGS. 5 to 7. As will be described below, only the operation is different from that of the portable terminal apparatus 10 according to the first embodiment. Hence, only points different from the operation of the portable terminal apparatus 10 according to the first embodiment will be described below.

Referring to FIG. 5, in the portable terminal apparatus according to the second embodiment, a first mail transmission section 112a and fourth mail transmission section 112d are arranged for Japanese 51 and English 52, respectively, in correspondence with attribute Type A corresponding to one mail transmission service. The fourth mail transmission section 112d allows two character types, i.e., alphabet and numbers. The maximum number of transmittable characters is 2,000.

Depending on the character type of an input mail text (for example, the text contains both English alphabet and Japanese characters or contains only English alphabet), a plurality of mail transmission sections that handle different character codes may be present in correspondence with one mail transmission service. For this reason, in this embodiment, the first mail transmission section 112a for Japanese and the fourth mail transmission section 112d for English are prepared.

In general, alphabet and numbers are used in, e.g., ASCII codes as a standard and have a small information amount per character. To the contrary, Japanese characters are not assigned in the ASCII codes and have a large information amount per character. For example, the fourth mail transmission section 112d for English allows not input of Japanese characters but only input of alphabet/numbers with a small character code information amount per character. Hence, the number of input characters of the fourth mail transmission section 112d is larger than that of the first mail transmission section 112a for Japanese.

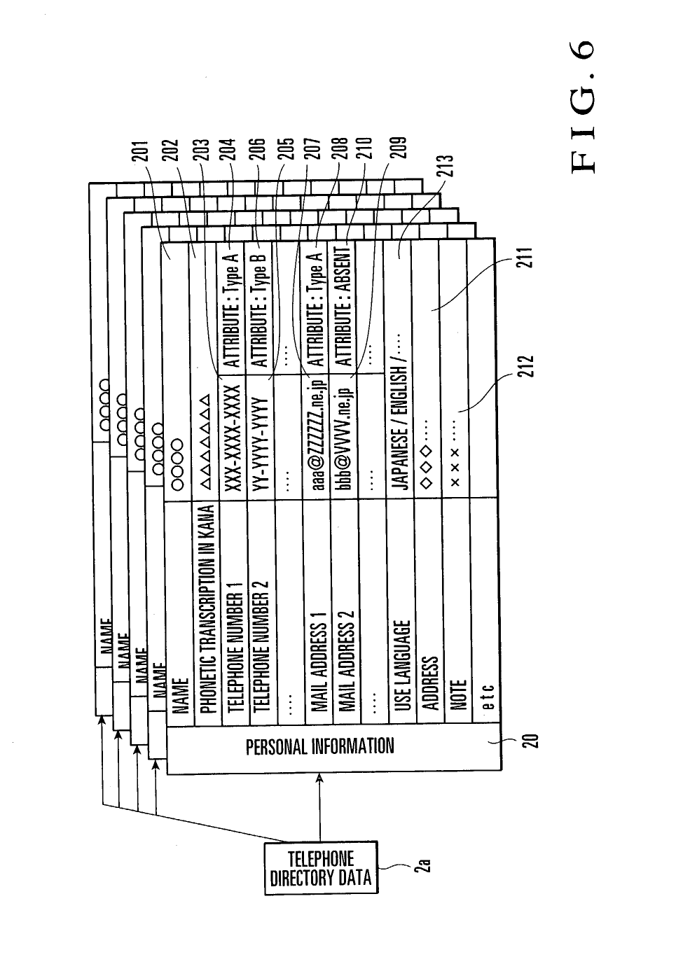

In the data structure of telephone directory data 2a according to this embodiment, as shown in FIG. 6, personal information 20 contains data representing the type of use language 213 in addition to attributes 204, 206, 208, and 210 added to destinations.

Normally, one language is used for one person. Hence, in this embodiment, one use language 213 is assigned to one person.

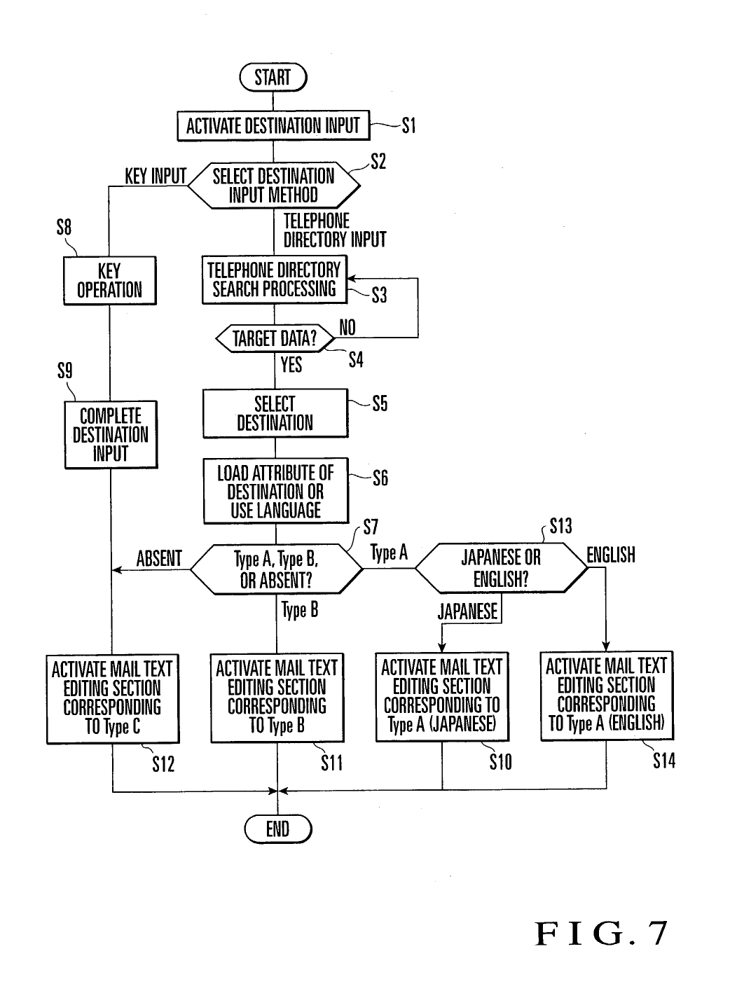

The operation of the portable terminal apparatus according to this embodiment will be described below with reference to FIG. 7 in association with only part different from the operation of the portable terminal apparatus 10 according to the first embodiment.

Steps S1 to S5 are executed as in the first embodiment, as shown in the flow chart of FIG. 7.

Information that represents the type of use language 213 is loaded simultaneously with the attribute of the destination (step S6).

Then, the attribute of the destination is determined (step S7).

When the attribute of the destination is Type A, it is further determined whether the type of use language 213 is Japanese or English (step S13).

When the use language 213 is Japanese, a first mail text editing section 113a is activated (step S10). Then the use language 213 is English, a fourth mail text editing section 113d is activated (step S14).

When the attribute of the destination is Type B, a second mail text editing section 113b is activated (step S11), as in the first embodiment. When no attribute is set for the destination, a third mail text editing section 113c is activated (step S12), as in the first embodiment.

As described above, in the second embodiment, even when one mail transmission service handles a plurality of character codes, and different mail transmission sections are used for the respective character codes, an optimum mail text editing section and mail transmission section can be automatically selected in accordance with the other party to which mail is to be transmitted.

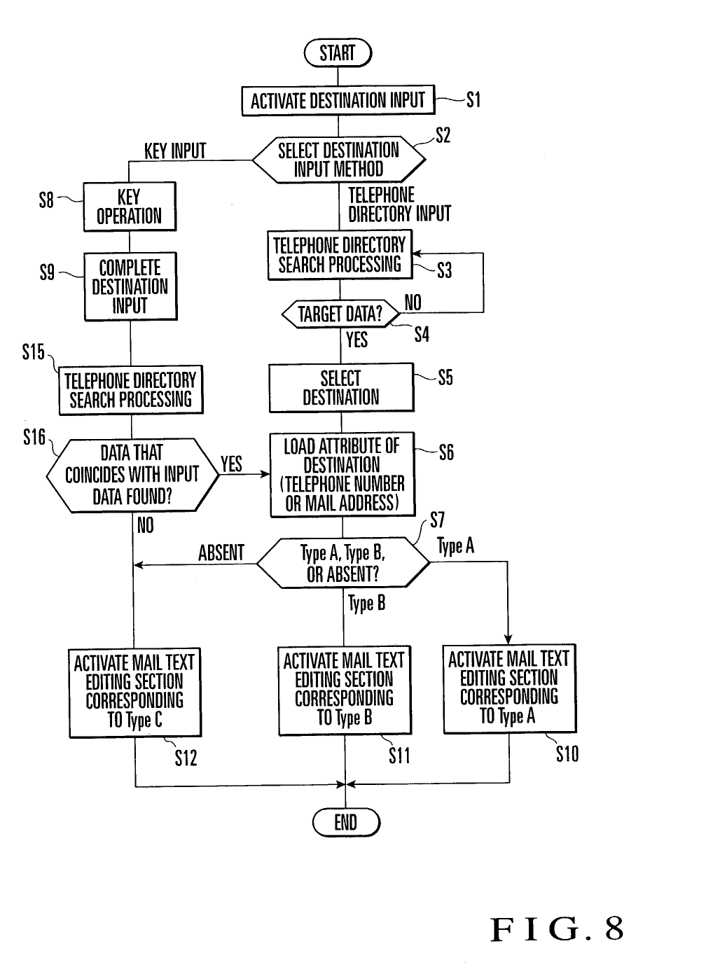

The operation of a portable terminal apparatus according to the third embodiment of the present invention will be described below with reference to FIG. 8 in association with only part different from the operation of the portable terminal apparatus 10 according to the first embodiment.

In the third embodiment, even when a destination is designated by key input, the attribute of the destination can be determined, and a mail transmission section corresponding to the attribute can be designated.

In selecting a destination input method (step S2), when the user selects key input (step S8), he/she directly inputs a destination by key operation.

When the destination input is completed (step S9), a control section 11 automatically activates a search processing section 14 (step S15) to search telephone directory data 2a (step S16).

This processing of searching the telephone directory data 2a is executed to automatically search whether a telephone number or mail address that completely coincides with the input destination is present, unlike processing (step S3) of searching the telephone directory data 2a for target personal information 20.

When the telephone directory data 2a is searched, and data that coincides with the input destination is found (YES in step S16), the attribute of the data is loaded (step S6). If no data that coincides with the input destination is present (NO in step S16), the destination is regarded to have no attribute.

In this case, in comparison between the input destination and the telephone directory data 2a, the input destination need not always completely coincide with data. Instead, the attribute may be designated on the basis of partial coincidence within a range in which a mail transmission section can be determined, like a case wherein a mail transmission section can be determined on the basis of the domain name of a mail address.

As described above, according to this embodiment, a mail transmission section corresponding to the attribute of a destination can be designated even for key input that the first embodiment cannot cope with.

When e-mail is to be transmitted, a data file is sometimes attached to the e-mail. Examples of attached data files are a text file containing only characters and symbols, an image file such as a GIF (Graphics Interchange Format) file, and a music file such as an MP3 (MPEG (Moving Picture Experts Group)-1 audio layer-III) file. When an attached file should be transmitted together with e-mail, it is sometimes necessary to select a mail transmission section in correspondence with the type of attached file because some mail transmission sections are unsuitable for transmission of the attached file.

In addition, the charging system may change depending on the capacity of the attached file and selection of the mail transmission section. Hence, it is necessary to select the mail transmission section of a charging system that is advantageous for the user.

Hence, in the portable terminal apparatus according to the fourth embodiment of the present invention to be described below, the presence/absence of an attached file and the capacity of the attached file are taken into consideration.

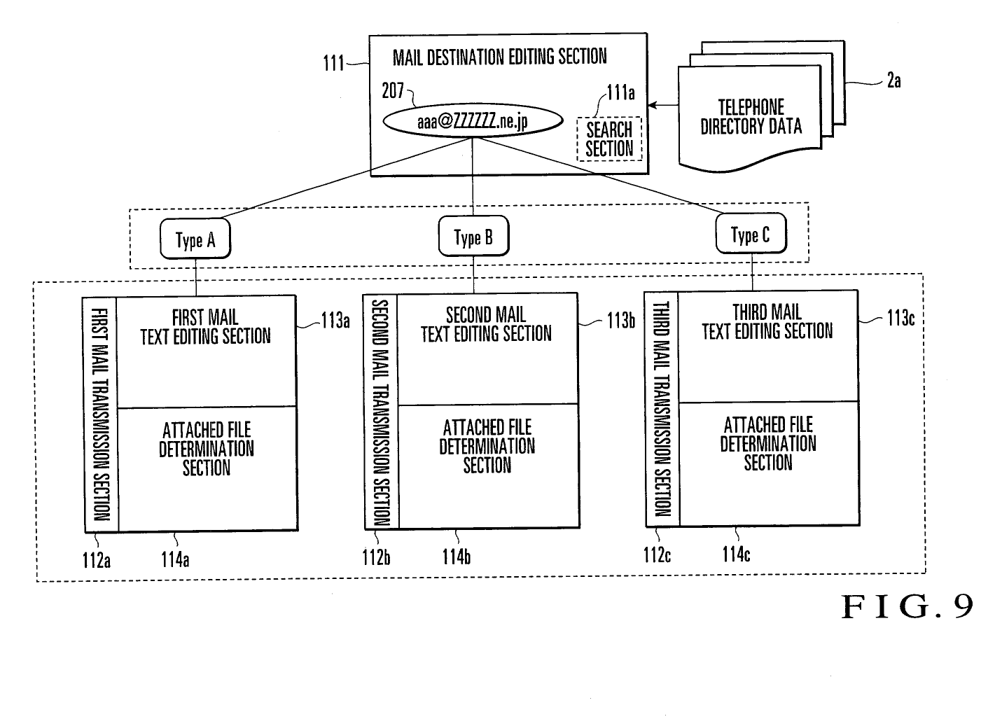

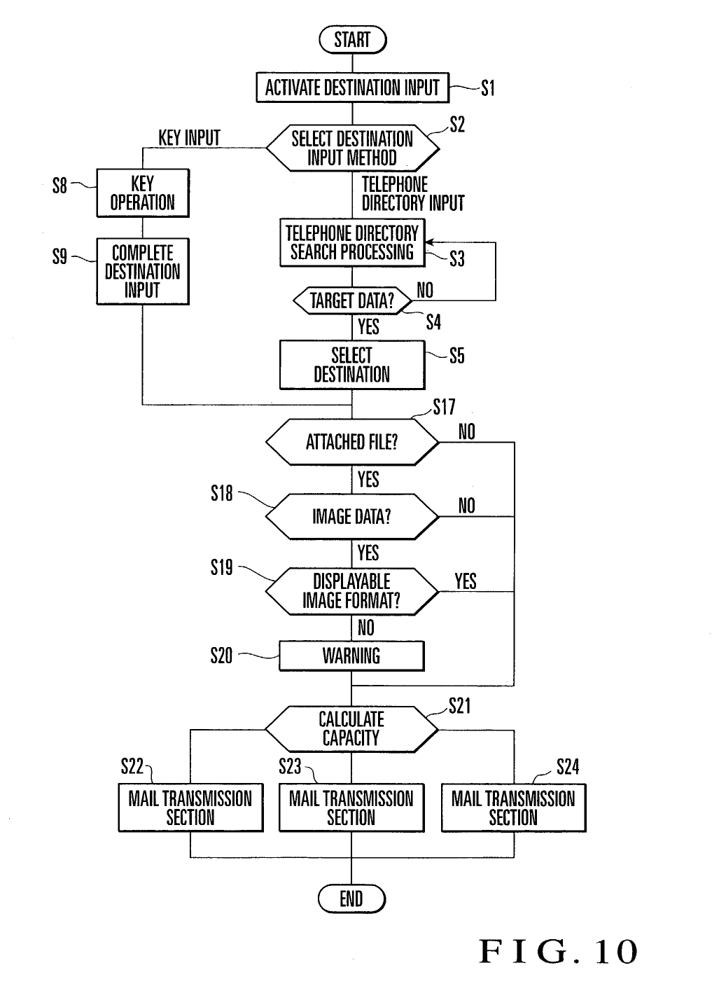

The operation of the portable terminal apparatus according to the fourth embodiment of the present invention will be described below with reference to FIGS. 9 and 10 in association with only part different from the operation of the portable terminal apparatus 10 according to the first embodiment.

In the portable terminal apparatus according to the fourth embodiment of the present invention, as shown in FIG. 9, a control section 11 has attached file determination sections (114a, 114b, and 114c).

After steps S1 to S5 and steps S8 and S9 are executed, as in the first embodiment, the attached file determination sections (114a, 114b, and 114c) of the control section 11 determine whether the e-mail has an attached file (step S17).

When an attached file is present (YES in step S17), the attached file determination sections (114a, 114b, and 114c) further determine whether the attached file is an image file (step S18).

When the attached file is an image file (YES in step S18), the attached file determination section determines the image format of the image data (step S19).

Some image formats cannot be displayed on the portable terminal apparatus at the transmission destination. When the attached image data has such an image format (NO in step S19), the attached file determination section displays, on a display section 12, a warning message “this image cannot be displayed at transmission destination” (step S20).

Next, the capacity of the attached file is calculated (step S21). If no attached file is present (NO in step S17), the attached file is not image data (NO in step S18), or the image data has an image format that can be displayed on the portable terminal apparatus at the transmission destination (YES in step S19), the capacity of the attached file is calculated after the determination in step S17, S18, or S19 (step S21).

For example, three capacity levels are prepared in advance, and mail transmission sections suitable for the respective levels are set in advance. Under these circumstances, the capacity of the attached file is calculated (step S21), and a mail transmission section is selected in accordance with the capacity of the attached file (step S22, S23, or S24).

The number of capacity levels is not limited to 3. An arbitrary number of 2 or more can be set.

As described above, according to the portable terminal apparatus of this embodiment, an appropriate mail transmission section is selected in accordance with the presence/absence of an attached file and the capacity of the attached file.

In recent years, there are a variety of charging systems including a packet charging system and flat-rate system. Hence, it is becoming more necessary to select a portable terminal apparatus connection method for e-mail transmission after creation of an e-mail text.

In a packet charging system as in a cellular phone network, a packet death may occur. To the contrary, in HotSpot (a public space where access points of wireless LAN (Local Area Network) are installed) that employs a flat-rate system, the capacity of data is irrelevant to the fee. For this reason, when connection by HotSpot becomes popular, it may call for a need for determining whether the cellular phone network or the wireless LAN should be selected as the portable terminal apparatus connection method.

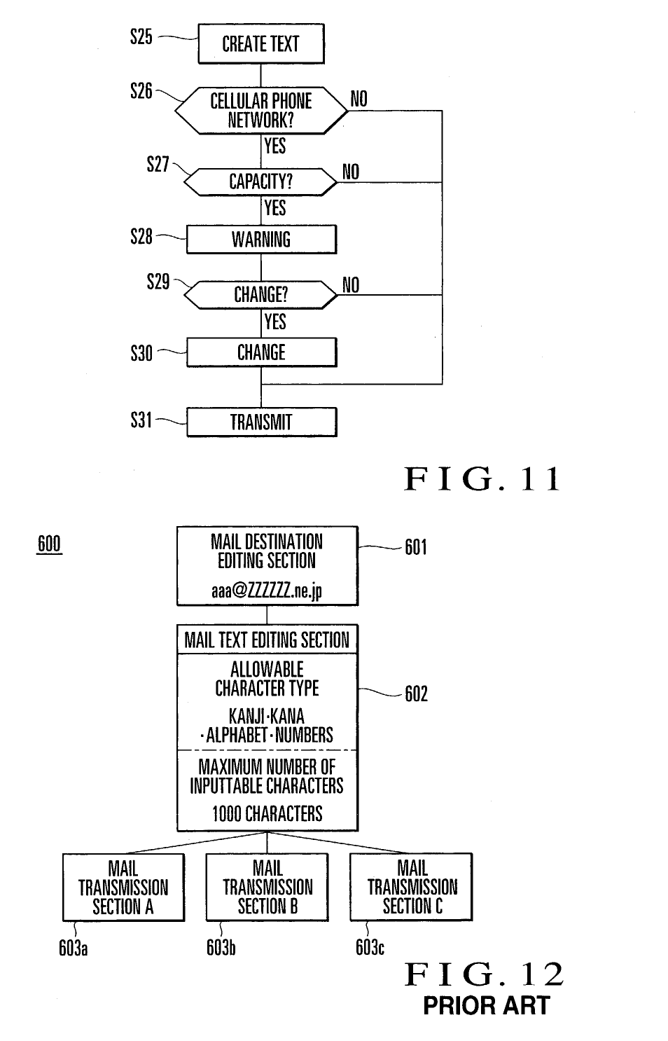

For example, as shown in FIG. 11, after an e-mail text is created (step S25), the control section 11 inquires of the user about whether the cellular phone network should be selected as the connection method (step S26). For example, a first mail transmission section 112a, second mail transmission section 112b, or third mail transmission section 112c of the control section 11 inquires of the user about whether the cellular phone network should be selected.

When the user selects the cellular phone network (YES in step S26), the control section 11 calculates the capacity of the e-mail (step S27). If connection by HotSpot is more advantageous for the user with that capacity value, the control section 11 displays a warning message representing it on the display section 12 (step S28).

Next, the control section 11 inquires of the user about whether the connection method should be changed from the cellular phone network to HotSpot (step S29).

When the user selects change (YES in step S29), the control section 11 changes the connection method from the cellular phone network to HotSpot (step S30). Then, the control section 11 transmits the e-mail (step S31).

When the user selects HotSpot from the beginning (NO in step S26), transmission by HotSpot is done (step S31). When the cellular phone network is selected, and the cellular phone network is more advantageous for the capacity of the e-mail (NO in step S27), or when the user does not want to change the connection method from the cellular phone network to HotSpot (NO in step S29), transmission by the cellular phone network is done (step S31).

The connection method selection method shown in FIG. 11 can be applied to all the first to fourth embodiments described above.

The operation of the control section 11 in the portable terminal apparatus according to each of the above-described first to fourth embodiments can also be executed by a computer program that is described using a computer-readable language.

To operate the control section 11 by a computer program, for example, a memory for storing the program is prepared in the portable terminal apparatus, and the computer program is stored in the memory. The control section 11 reads out the computer program from the memory and executes the above-described operation in accordance with the computer program.

Alternatively, when a storage medium that stores the computer program is set in the control section 11, the control section 11 can read out the computer program from the storage medium and execute the above-described operation in accordance with the computer program.

As has been described above, according to the present invention, in a portable terminal apparatus which can use a plurality of mail transmission services, a specific mail transmission service is automatically designated in accordance with an input e-mail destination, and a mail text editing section having character types and number of inputtable characters, which are allowable in the designated mail transmission service, is activated. Accordingly, the user can edit the text of e-mail without being aware of the limitations on the character types and the number of inputtable characters.

For example, a destination contained in specific personal information searched from telephone directory data which stores destination information of a plurality of persons is input to the mail destination editing section. The destination of the personal information has an attribute that designates a mail transmission section to be used for transmission to the destination. The control section determines the destination of the other party of the transmission and then automatically activates a mail text editing section corresponding to the attribute of the mail transmission section from a plurality of mail text editing sections. Each of the mail text editing sections corresponding to individual attributes has predetermined allowable character types and number of inputtable characters in accordance with a mail transmission service. For this reason, it is impossible to input unallowable character types and characters more than the inputtable number.

In this way, in the portable terminal apparatus that copes with a plurality of mail transmission services, the user can edit a mail text and transmits the mail without being aware of character types that do not cope with each mail transmission service or character input more than the transmittable number.

In addition, the user need not edit the mail text while being aware of the mail transmission service of the other party. This is because an attribute for mail transmission service selection is added to each destination data of personal information in the telephone directory data.

Furthermore, the number of transmission errors due to an input error (character type selection error or character input more than the allowable number) in text editing by the user can be decreased. This is because the mail transmission section and mail text editing section can be automatically selected in accordance with the attribute of the transmission destination (mail transmission service belonging to the destination), and input of unallowable characters or characters more than the transmittable number defined in the mail transmission service can be prevented. This is also because a transmission sequence corresponding to the mail transmission service can be automatically used at the time of mail transmission.

What is claimed is:

1. A portable terminal apparatus comprising:
radio means for transmitting/receiving a radio signal;
data input means for inputting data;
display means for displaying the data input by said input means;
a memory which stores the data;
a plurality of mail transmission means, arranged in correspondence with a plurality of mail transmission services, for transmitting mail;
a plurality of mail text editing means, arranged in correspondence with the plurality of mail transmission services, for editing e-mail within a mail transmission condition defined for each mail transmission service; and
mail destination editing means for designating a mail transmission service in accordance with a destination, activating a corresponding one of said mail text editing means, and editing the destination of the other party to which the e-mail is to be transmitted.

2. An apparatus according to claim 1, wherein
said memory stores telephone directory data containing a telephone number and mail address of each person, each of the telephone number and mail address having an attribute corresponding to a mail transmission service, and
when one of the telephone number and mail address is input as the destination of the e-mail, said mail destination editing means specifies the attribute corresponding to one of the telephone number and mail address on the basis of the telephone directory data and activates mail text editing means corresponding to the mail transmission service corresponding to the attribute.

3. An apparatus according to claim 1, further comprising said mail text editing means equal in number to the plurality of mail transmission services to which said portable terminal apparatus cope with.

4. An apparatus according to claim 1, further comprising a plurality of mail transmission means corresponding to languages to be used for an attribute corresponding to one mail transmission service.

5. An apparatus according to claim 1, wherein
said memory comprises telephone directory data containing a telephone number and mail address of each person, each of the telephone number and mail address having an attribute corresponding to a mail transmission service,
said data input means comprises a plurality of keys to be used to input the data, and
when one of the telephone number and mail address is input through said keys as the destination of the e-mail, said mail destination editing means searches the telephone directory data for one of a telephone number and mail address, which coincides with the input one of the telephone number and mail address, and when one of the telephone number and mail address, which coincides with the input one of the telephone number and mail address, is present, activates mail text editing means corresponding to the mail transmission service corresponding to the attribute of one of the telephone number and mail address.

6. An apparatus according to claim 5, further comprising search means for searching the telephone directory data for one of a telephone number and mail address, which partially coincides with the input one of the telephone number and mail address.

7. An apparatus according to claim 1, wherein
said memory comprises telephone directory data containing a telephone number and mail address of each person, each of the telephone number and mail address having an attribute corresponding to a mail transmission service,
said data input means comprises a plurality of keys to be used to input the data, and
when one of the telephone number and mail address is input through said keys as the destination of the e-mail, said mail destination editing means searches the telephone directory data for a telephone number or mail address, which coincides with the input one of the telephone number and mail address, and when one of the telephone number and mail address, which coincides with the input one of the telephone number and mail address, is not present, activates said mail text editing means defined in advance.

8. An apparatus according to claim 2, further comprising search processing means for reading out data from the telephone directory data.

9. An apparatus according to claim 1, further comprising attached file determination means for, when one of a telephone number and mail address is input as the destination of the e-mail, determining whether the e-mail has an attached file, and when the attached file is present, activating one of said mail text editing means in accordance with a capacity of the attached file.

10. An apparatus according to claim 9, wherein when the attached file is image data, said attached file determination means displays, in accordance with an image format, a message representing that the image cannot be displayed at the transmission destination on said display means and then transmits the e-mail together with the attached file.

11. An apparatus according to claim 9, wherein when the attached file is image data and has a capacity not less than a threshold value, said attached file determination means selects new mail transmission means.

12. An apparatus according to claim 1, wherein said mail transmission means, said mail text editing means, and said mail destination editing means constitute control means.

13. A mail editing method in a portable terminal apparatus, comprising the steps of:
inputting a destination of the other party of a mail transmission destination to the terminal apparatus;
causing the portable terminal apparatus to specify an attribute corresponding to the destination;
causing the portable terminal apparatus to activate one of mail text editing means in correspondence with the attribute; and
editing a mail text within a mail transmission condition defined for a mail transmission service corresponding to the activated mail text editing means.

14. A method according to claim 13, wherein the attribute specifying step comprises the step of, when one of a telephone number and mail address is input as the destination of the e-mail in the input step, specifying an attribute corresponding to one of the telephone number and mail address on the basis of telephone directory data containing a telephone number and mail address of each person, each of the telephone number and mail address having an attribute corresponding to a mail transmission service.

15. A method according to claim 13, wherein
the method further comprises the step of, when one of a telephone number and mail address is input through keys as the destination of the e-mail in the input step, causing the portable terminal apparatus which has a plurality of keys to be used to input the data and telephone directory data containing a telephone number and mail address of each person, each of the telephone number and mail address having an attribute corresponding to a mail transmission service to search the telephone directory data for one of a telephone number and mail address, which coincides with the input one of the telephone number and mail address, and
the activation step comprises the step of, when one of the telephone number and mail address, which coincides with the input one of the telephone number and mail address, is found in the search step, activating mail text editing means corresponding to the mail transmission service corresponding to the attribute of one of the telephone number and mail address.

16. A method according to claim 13, wherein the search step comprises the step of searching the telephone directory data for one of a telephone number and mail address, which partially coincides with the input one of the telephone number and mail address.

17. A method according to claim 13, further comprising the steps of
when one of a telephone number and mail address is input through keys as the destination of the e-mail in the input step, causing the portable terminal apparatus which has a plurality of keys to be used to input the data and telephone directory data containing a telephone number and mail address of each person, each of the telephone number and mail address having an attribute corresponding to a mail transmission service to search the telephone directory data for a telephone number or mail address, which coincides with the input one of the telephone number and mail address, and
when one of the telephone number and mail address, which coincides with the input one of the telephone number and mail address, is not found in the search step, activating mail text editing means that is defined in advance to be activated when no attribute is present.

18. A method according to claim 13, further comprising the steps of
when one of a telephone number and mail address is input as the destination of the e-mail, causing the portable terminal apparatus to determine whether the e-mail has an attached file, and
when the attached file is found in the determination step, causing the portable terminal apparatus to activate mail text editing means in accordance with a capacity of the attached file.

19. A method according to claim 18, further comprising the steps of
when the attached file is image data, causing the portable terminal apparatus to display, in accordance with an image format, a message representing that the image cannot be displayed at the transmission destination, and
transmitting the e-mail together with the attached file.

20. A method according to claim 18, further comprising the step of, when the attached file is image data and has a capacity not less than a threshold value, causing the portable terminal apparatus to select new mail transmission means.

21. A recording medium which stores a program for causing a computer to execute a mail editing method in a portable terminal apparatus, wherein the program comprises a program which causes the computer to execute the steps of:
when a user of the portable terminal apparatus inputs a destination of the other party of a mail transmission destination to the portable terminal apparatus, specifying an attribute corresponding to the destination;
activating mail text editing means corresponding to the attribute; and
transmitting a mail text that is edited by the user within a mail transmission condition defined for a mail transmission service corresponding to the activated mail text editing means.

22. A medium according to claim 21, wherein the program comprises a program which causes the computer to execute the step of, when one of a telephone number and mail address is input as the destination of the e-mail, specifying an attribute corresponding to one of the telephone number and mail address on the basis of telephone directory data containing a telephone number and mail address of each person, each of the telephone number and mail address having an attribute corresponding to one of a plurality of mail transmission services.

23. A medium according to claim 21, wherein the program comprises a program which causes the computer to execute the steps of
when one of a telephone number and mail address is input as the destination of the e-mail through a plurality of keys that are arranged in the portable terminal apparatus to input the data, searching telephone directory data containing a telephone number and mail address of each person, each of the telephone number and mail address having an attribute corresponding to one of a plurality of mail transmission services for one of a telephone number or mail address, which coincides with the input one of the telephone number and mail address, and
when one of the telephone number and mail address, which coincides with the input one of the telephone number and mail address, is present, activating mail text editing means corresponding to the mail transmission service corresponding to the attribute of one of the telephone number and mail address.

24. A medium according to claim 21, wherein the program comprises a program which causes the computer to execute the step of searching the telephone directory data for one of a telephone number and mail address, which partially coincides with the input one of the telephone number and mail address.

25. A medium according to claim 21, wherein the program comprises a program which causes the computer to execute the steps of
when one of a telephone number and mail address is input as the destination of the e-mail through a plurality of keys that are arranged in the portable terminal apparatus to input the data, searching telephone directory data containing a telephone number and mail address of each person, each of the telephone number and mail address having an attribute corresponding to each mail transmission service for one of a telephone number or mail address, which coincides with the input one of the telephone number and mail address, and
when one of the telephone number and mail address, which coincides with the input one of the telephone number and mail address, is not present, activating mail text editing means that is defined in advance to be activated when no attribute is present.

26. A medium according to claim 21, wherein the program comprises a program which causes the computer to execute the steps of
when one of a telephone number and mail address is input as the destination of the e-mail, determining whether the e-mail has an attached file, and
when the attached file is present, activating mail text editing means in accordance with a capacity of the attached file.

27. A medium according to claim 21, wherein the program comprises a program which causes the computer to execute the steps of
when the attached file is image data, displaying, in accordance with an image format, a message representing that the image cannot be displayed at the transmission destination on the portable terminal apparatus, and
after the display step, transmitting the e-mail together with the attached file.

28. A medium according to claim 21, wherein the program comprises a program which causes the computer to execute the step of, when the attached file is image data and has a capacity not less than a threshold value, selecting new mail transmission means.
